(19) United States
(12) Patent Application Publication
(10) Pub. No.: US 2011/0096028 A1
(43) Pub. Date: Apr. 28, 2011

(54) ELECTRONIC DEVICE WITH INFRARED TOUCH PANEL AND TOUCH INPUT METHOD THEREOF

(75) Inventors: XIN ZHAO, Shenzhen City (CN); XIAO-GUANG LI, Shenzhen City (CN); RUEY-SHYANG YOU, Tu-Cheng (TW); HAN-CHE WANG, Tu-Cheng (TW); KUAN-HONG HSIEH, Tu-Cheng (TW)

(73) Assignees: HONG FU JIN PRECISION INDUSTRY(SheZhen) CO., LTD., Shenzhen City (CN); HON HAI PRECISION INDUSTRY CO., LTD., Tu-Cheng (TW)

(21) Appl. No.: 12/871,832

(22) Filed: Aug. 30, 2010

(30) Foreign Application Priority Data
Oct. 23, 2009 (CN) 200910308696.3

(51) Int. Cl. G06F 3/042

(52) U.S. Cl. 345/175

(57) ABSTRACT

A touch input method includes steps: controlling one of the infrared emitters to turn on and send an infrared signal to the infrared receivers in sequence, thus forming a number of first infrared lines. Detecting whether an infrared receiver does not receive the infrared signal. Determining if the first infrared line is blocked by an object, thus determining a first blocked infrared line. Controlling the other infrared emitter to turn on and send the infrared signal to the infrared receivers, thus forming a number of second infrared lines. Determining if the second infrared line is blocked by the object, thus determining a second blocked infrared line. Determining touch position according to the first and the second blocked infrared lines, executing the function of a GUI element corresponds to the touch position. The disclosure also provides an electronic device with an infrared touch panel.

### BACKGROUND

1. Related Applications

Relevant subject matter is disclosed in a copending application entitled, “ELECTRONIC DEVICE WITH INFRARED TOUCH PANEL AND METHOD FOR CONFIGURING THE INFRARED TOUCH PANEL”, filed **** (Atty. Docket No. US29383), and assigned to the same assignee as named herein.

2. Technical Field

The present disclosure relates to electronic devices with touch panels and, particularly, to an electronic device with an infrared touch panel, and a touch input method thereof.

3. Description of Related Art

Nowadays, electronic devices equipped with touch panels are very popular. Infrared matrix type touch panels are commonly used. A conventional infrared matrix type touch panel has horizontal and vertical infrared emission and detection arrays that are arranged on four sides of the panel to produce infrared rays in the shape of very close cross stripes on the panel. When an object touches a spot on the panel, the object blocks an infrared ray passing through the touched spot, and the position information of the touched spot is determined by detecting which infrared ray is blocked.

However, in conventional infrared matrix type touch panels, the emission and detection arrays need the same numbers of emitters and detectors, which increase the cost.

Therefore, it is desirable to provide an electronic device with infrared touch panels, which can overcome the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an exploded view of an electronic device with an infrared touch panel, according to an exemplary embodiment.

FIG. 2 is a block diagram of the electronic device of FIG. 1.

FIG. 3 is a schematic view of the electronic device of FIG. 1.

FIG. 4 is a schematic view of the electronic device displaying an icon, which shows the relation between the icon and infrared lines.

FIG. 5 is a flowchart illustrating a touch input method for controlling the electronic device of FIG. 1, in accordance with an exemplary embodiment.

### DETAILED DESCRIPTION

Embodiments of the present disclosure will now be described in detail below, with reference to the accompanying drawings.

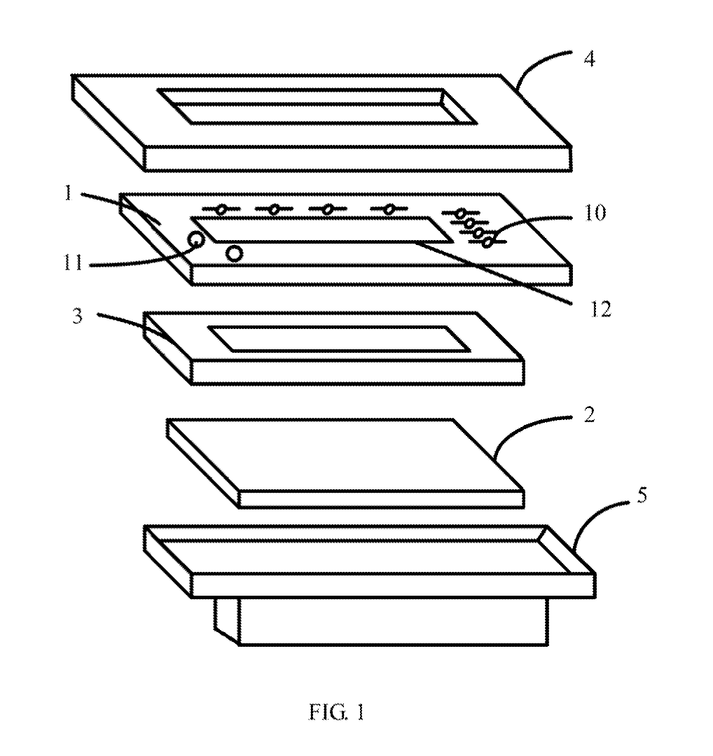

Referring to FIG. 1, an electronic device 100 includes an infrared touch panel 1, a processing unit 2, a display unit 3, a frame 4, and a cover 5. The frame 4 and the cover 5 cooperatively form a space to receive the infrared touch panel 1, the display unit 3, and the processing unit 2. The processing unit 2 is connected to the infrared touch panel 1 and the display unit 3. The infrared touch panel 1 includes several infrared receivers 10, at least two emitters 11, and a circuit board 12. In the embodiment, the circuit board 12 is substantially rectangular. The infrared receivers 10 and the infrared emitters 11 are set on the circuit board 12.

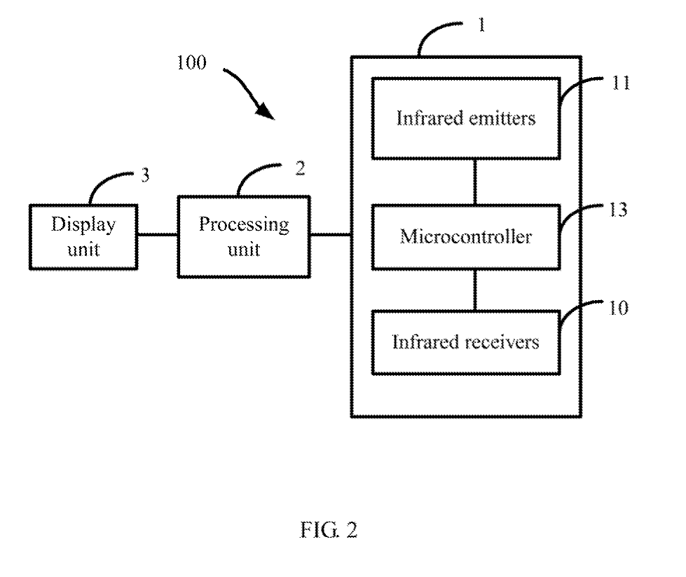

Referring also to FIG. 2, the infrared touch panel 1 also includes a microcontroller 13 set on the circuit board 12. The microcontroller 13 is connected to the infrared receivers 10 and the infrared emitters 11, and is configured to control the infrared emitters 11 to send infrared signals to the infrared receivers 10 in sequence. When one of the infrared emitters 11 emits infrared signals to the infrared receivers 10, the infrared lines corresponding to the infrared signals are formed between the infrared emitter 11, which is currently emitting infrared signals to the infrared receivers 10. The microcontroller 13 is also configured to determine that whether an object, such as a finger or a stylus, blocks an infrared line. In one embodiment, if one infrared receiver 10 does not receive an infrared signal from the infrared emitter 11, then the microcontroller 13 determines an object has blocked the infrared line corresponding to the infrared signal.

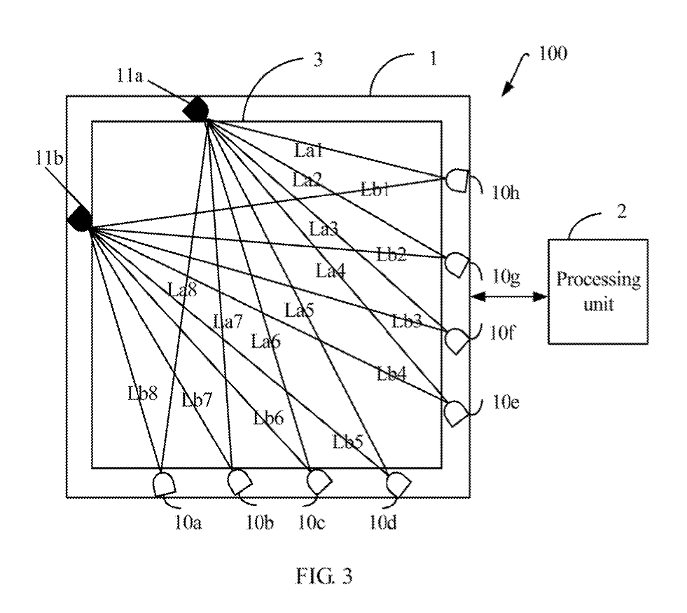

Referring also to FIG. 3, in the embodiment, the number of the infrared emitters 11 is two, which are infrared emitter 11a and 11b, and the number of the infrared receivers 10 is eight, which are infrared receivers 10a˜10h. In the embodiment, the infrared emitters 11a, 11b are respectively set on the left side and the upper side of the circuit board 12 and close to the top left corner of the circuit board 12. The eight infrared receivers 10a-10h are set on the bottom side and the right side of the circuit board 12 and are distributed uniformly. The infrared emitter 11a is capable of transmitting infrared signals to the eight infrared receivers 10a-10h, thus eight infrared lines La1˜La8 are formed between the infrared emitter 11a and the eight infrared receivers 10a˜10h. The infrared emitter 11b is capable of transmitting infrared signals to the eight infrared receivers 10a˜10h, thus eight infrared lines Lb1˜Lb8 are formed between the infrared emitter 11b and the eight infrared receivers 10a˜10h. The numbers and the arrangements of the infrared emitters 11 and the infrared receivers 10 can vary according to need. For example, the number of the infrared emitters 11 may be three, and the number of the infrared receivers 10 may be ten.

The infrared lines La1˜La8 and the infrared lines Lb1˜Lb8 form cross-points (not labeled). Each cross-point corresponds to a touch position of the infrared touch panel 1. The display unit 3 is capable of displaying icons and other graphic user interface (GUI) elements under the control of the processing unit 2. The phrase “GUI element” means an icon or a label, which is displayed on the display unit and is capable of triggering a function in response to user's touch. In the embodiment, each GUI element is corresponding to a touch position, thus when a touch position of the infrared panel 1 is touched by the user, the GUI element corresponding to the touch position will be determined by the processing unit 2 and the function corresponding to the GUI element is executed by the processing unit 2. In the embodiment, the phrase “touch” means contact the infrared touch panel 1 or in proximity to rather than contact.

The microcontroller 13 is further configured to output control signals to turn on or turn off the infrared emitters 11a and 11b in sequence. When the infrared emitter 11a is turned on, the infrared emitter 11a sends infrared signals to the infrared receivers 10a˜10h. When the infrared emitter 11b is turned on, the infrared emitter 11b sends infrared signals to the infrared receiver 10a˜10h. For example, when the control signal output by the microcontroller 13 is “0”, the infrared emitter 11a is turned on and sends the infrared signal to the infrared receivers 10a˜10h. When the control signal output by the microcontroller 13 is “1”, the infrared emitter 11b is turned on and sends the infrared signal to the infrared receivers 10a˜10h. The control signal is changed periodically to turn on or turn off the infrared emitter 11a and 11b alternately.

The microcontroller 13 detects whether an infrared receiver does not receive the infrared signal. If an infrared receiver does not receive the infrared signal, the microcontroller 13 further determines which of the infrared emitters 11a or 11b is currently turned on according to the control signal output by it. The microcontroller 13 then determines that the infrared line between the infrared receiver, which does not receive the infrared signal and the infrared emitter, which is turned on, is blocked.

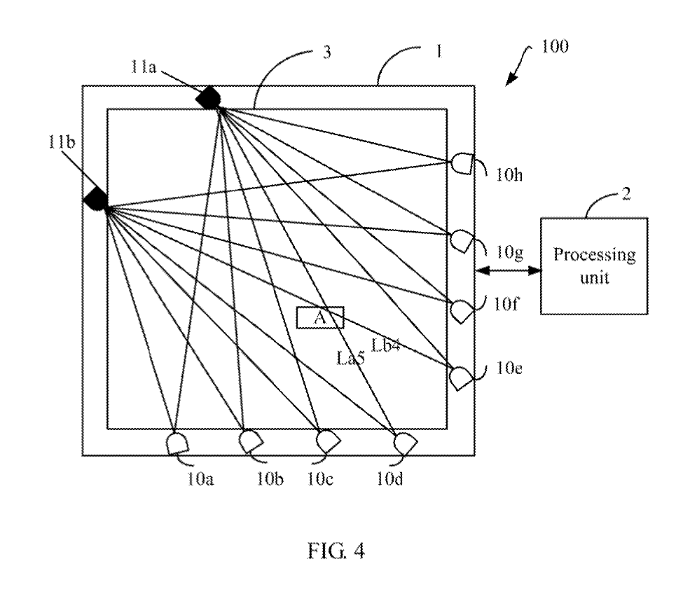

Referring to FIG. 4, the display unit 3 displays an icon A corresponding to the cross-point of the infrared line La5 and Lb4. When a touch position corresponding to the icon A is touched, the infrared receivers 10d and 10e fail to receive the infrared signal. As described above, the infrared emitters are turned on in sequence, namely, at one time, only one of the infrared emitters 11a and 11b sends infrared signals to the infrared receivers 10a˜10h. When the infrared emitter 11a is turned on, the microcontroller 13 detecting the infrared receiver 10d does not receive the infrared signal, and determines that the infrared line La5 between the infrared emitter 11a and the infrared receiver 10d is blocked, thus determining a first blocked infrared line. When the infrared emitter 11b is turned on, the microcontroller 13 detects that the infrared receiver 10e does not receive the infrared signal, and determines the infrared line Lb4 between the infrared emitter 11b and the infrared receiver 10e is blocked, thus determining a second blocked infrared line.

The microcontroller 13 transmits first information including the first blocked infrared line and second information including the second blocked infrared line to the processing unit 2, the processing unit 2 determines the touch position according to the blocked infrared line La5 and Lb4. In the embodiment, the infrared emitter 11a and 11b, and the infrared receivers 10a˜10h each correspond to a coordinate/position of a coordinate system, such as an X-Y coordinate system. The processing unit 2 determines the two infrared receivers 10d and 10e, which do not receive the infrared signal according to the blocked infrared line La5 and Lb4. The processing unit 2 then calculates the coordinate of the cross-point of the infrared line La5 and Lb4 according to the coordinates of the infrared emitter 11a and 11b, and the infrared receiver 10d and 10e, thus determining the touch position corresponding to the cross-point of the infrared line La5 and Lb4. The processing unit 2 further determines the GUI element corresponding to the touch position, and executes the function of the GUI element. For example, if the processing unit 2 determines the icon displayed on the display unit 3 is an email icon, then the microcontroller 13 executes email function.

After the processing unit 2 executes the function, the processing unit 2 deletes the first information and the second information.

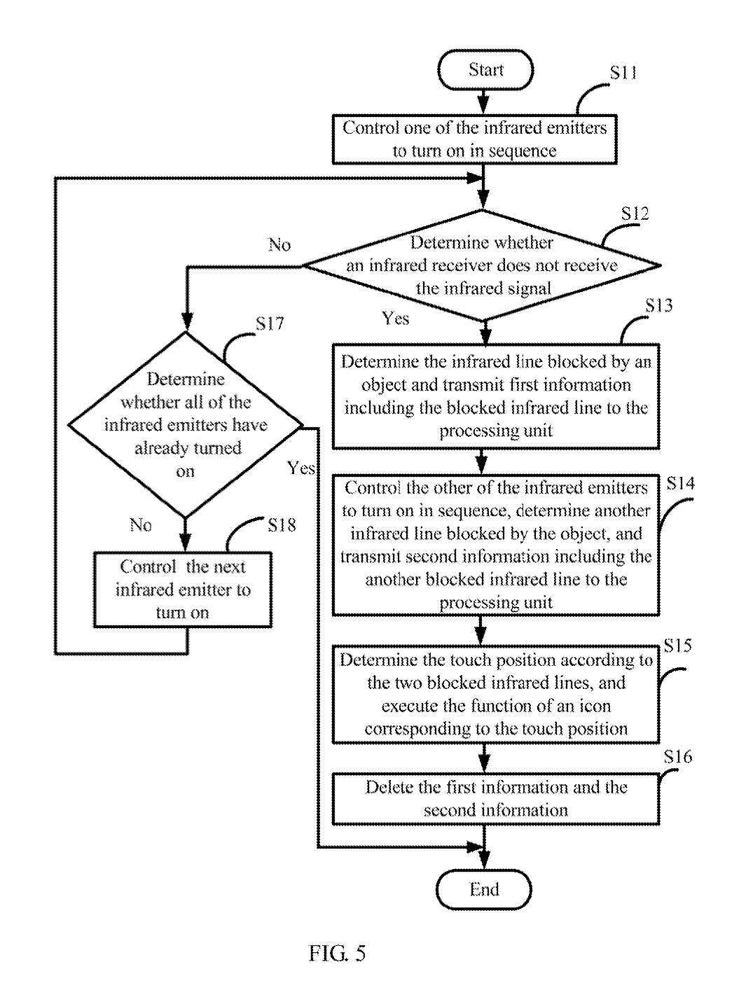

FIG. 5 is a flowchart illustrating a touch input method for controlling an electronic device in accordance with an exemplary embodiment.

In step S11, the microcontroller 13 controls one of the infrared emitters 11 to emit infrared signals. In one embodiment, in a cycle, the microcontroller 13 first controls the infrared emitter 11a to emit infrared signals, and then controls the infrared emitter 11b to emit infrared signals.

In step S12, the microcontroller 13 determines whether an infrared receiver does not receive the infrared signal when the infrared emitter 11 emits an infrared signal.

If the microcontroller 13 determines that all of the infrared receivers 10 have received the infrared signal, the process goes to step S17. Otherwise, in step S13, the microcontroller 13 determines that the infrared line corresponding to the infrared receiver 10, which does not receive the infrared signal, is blocked by an object and transmits the first information including the blocked infrared line to the processing unit 2.

In step S14, the microcontroller 13 controls the other infrared emitters 11 to emit infrared signals, determines another infrared line blocked by the object, and transmits second information including the another blocked infrared line to the processing unit 2.

In step S15, the processing unit 2 determines the touch position according to the two blocked infrared lines, determines the icon displayed on the display unit 3 corresponding to the touch position, and executes the function of the icon.

In step S16, the processing unit 2 deletes the first information and the second information, and the process ends and starts a new cycle.

In step S17, the microcontroller 13 determines whether all of the infrared emitters have already emitted the infrared signal.

If all of the infrared emitters have emitted the infrared signal, the process ends and a new cycle starts. Otherwise, in step S18, the microcontroller 13 controls the next infrared emitter to turn on and emit infrared signals, and the process returns to step S12.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
an infrared touch panel, comprising:
two infrared emitters to emit infrared signals;
a plurality of infrared receivers to receive infrared signals from the infrared emitters; and
a microcontroller connected to the infrared emitters and the infrared receivers, and configured for controlling the two infrared emitters to emit the infrared signals to the infrared receivers to form a plurality of infrared lines alternately and further to detect whether an infrared line is blocked, and transmitting information including the blocked infrared line to a processing unit;
a display unit, configured for displaying at least one graphic user interface (GUI) element on at least one touch position corresponding to at least one cross-point formed by the infrared lines emitted by the two infrared emitters, under the control of the processing unit; and
the processing unit to determine the touch position according to the blocked infrared lines emitted by the two infrared emitters, and determine one of the at least one GUI element corresponding to the touch position, and execute the function corresponding to the GUI element.

2. The electronic device according to claim 1, further comprising a front frame and a back cover; the infrared touch panel, the display unit, and the processing unit are received between the front frame and the back cover in sequence.

3. The electronic device according to claim 1, wherein, when the microcontroller detects there is one infrared receiver which does not receive the infrared signal, the microcontroller determines the infrared emitter turned on currently, and determines that the infrared line between the infrared receiver not receiving the infrared signal and the infrared emitter which is turned on currently is blocked, then obtains a first blocked infrared line; the microcontroller further determines another infrared receiver which does not receive the infrared signal when the other infrared emitter is turned on, and determines that the infrared line between the infrared receiver does not receive the infrared signal and the other infrared emitter which is turned on currently is blocked, then obtains a second blocked infrared line.

4. The electronic device according to claim 3, wherein the two infrared emitters and the infrared receivers each correspond to a position of a coordinate system; the processing unit receives first information including the first blocked infrared line and second information including the second blocked infrared line from the microcontroller, and determines the two infrared receivers which do not receive the infrared signal according to the first and the second blocked infrared lines, and calculates a coordinate of the cross-point of the first and the second blocked infrared lines according to the coordinates of the two infrared emitters, the two infrared receivers which do not receive the infrared signal, thus obtaining the touch position.

5. The electronic device according to claim 4, the processing unit deletes the first and the second information after executing the function corresponds to the icon.

6. The electronic device according to claim 1, wherein the infrared touch panel further comprises a circuit board to hold the two infrared emitters, the infrared receiver, and the microcontroller, the two infrared emitters, and the infrared receiver are set at the edge of the circuit board.

7. A touch input method applied in an electronic device, the electronic device comprises a display unit to display at least one graphic user interface (GUI) element, two infrared emitters, and a plurality of infrared receivers, the method comprising:
controlling one of the infrared emitters to turn on and send an infrared signal to the infrared receivers in sequence, thus forming a plurality of first infrared lines;
detecting whether an infrared receiver does not receive the infrared signal;
determining that one of the first infrared lines corresponding to the infrared receiver not receiving the infrared signal is blocked by an object, thus determining a first blocked infrared line;
controlling the other infrared emitter to turn on and send the infrared signal to the infrared receivers, thus forming a plurality of second infrared lines;
determining that one of the second infrared lines corresponding to the infrared receiver not receiving the infrared signal is blocked by the object, thus determining a second blocked infrared line;
determining touch position according to the first and the second blocked infrared lines;
executing the function of one of the at least one GUI element corresponding to the touch position.

8. The touch input method according to claim 7, further comprising:
deleting the information of the first blocked infrared line and the second blocked infrared line after executing the function of the GUI element.

9. The touch input method according to claim 7, wherein the two infrared emitters and a plurality of infrared receivers each correspond to a position of a coordinate system, the step “determining touch position according to the first and the second blocked infrared lines” comprises:
determining the two infrared receivers which do not receive the infrared signal according to the first and the second blocked infrared lines;
calculating a coordinate of the cross-point of the first and the second blocked infrared lines according to the coordinates of the two infrared receivers which do not receive the infrared signal and the two infrared emitter;
determining the touch position corresponding to the coordinate of the cross-point of the first and the second blocked infrared lines.
